(19) United States
(12) Patent Application Publication
(10) Pub. No.: US 2026/0304126 A1
(43) Pub. Date: Oct. 1, 2026

(54) ADAPTIVE SECURITY GATEWAY TUNNEL INTERNAL ADDRESS ARBITRATION FOR TELECOMMUNICATIONS SYSTEMS AND APPLICATIONS

(71) Applicant: T-MOBILE INNOVATIONS LLC, Overland Park, KS (US)

(72) Inventor: Amitav NAYAK, South Riding, VA (US)

(21) Appl. No.: 19/093,502

(22) Filed: Mar. 28, 2025

(51) Int. Cl. H04W 12/088; H04W 12/033

(52) U.S. Cl. CPC H04W 12/088; H04W 12/033

(57) ABSTRACT

Embodiments for adaptive security gateway tunnel internal address arbitration for telecommunications systems and applications are provided. A security gateway (SeGW) used by a network access node may include an adaptive internal tunnel address arbitrator for processing SeGW connection requests (e.g., Internet Key Exchange (IKE)-AUTH messages) from network access nodes. The arbitrator may be used to control the inner tunnel network address assignment process to minimize dropped IPSec tunnels when an IRAC authentication is successful, but a requested static inner IP address could not be allocated. Where an SeGW cannot provide the access node with a requested static address, as long as the access node's certificate is validated, the arbitrator may instead allocate an available dynamic inner IP address. The arbitrator advantageously facilitates maintaining a validly established IPSec tunnel by permitting the SeGW to assign an inner tunnel IP address from its pool of available dynamic IP addresses.

### BACKGROUND

Mobile communication networks utilize a combination of macrocells and small cell antennas to provide comprehensive coverage. Macrocells, such as an eNodeB for 4G long term evolution (LTE) cellular and/or a gNodeB for 5G cellular, cover large areas, while small cell antennas are deployed in areas with high user density or limited coverage, such as urban environments or college campuses. These small cell antennas connect to the network core via the Internet, using a security gateway (SeGW) to establish an IPSec tunnel that encrypts the data traffic. When a small cell node connects to the SeGW via the Internet, it establishes an outer tunnel for internet protocol (IP) communication. Macrocells and small cell antennas, may define clients (e.g., such as an internet protocol security remote access client (IRAC)) of a SeGW defining a server (e.g., such as an internet protocol security remote access server (IRAS)), where the client and server use internet key exchange version 2 (IKEv2) for IP security (IPSec) tunnel establishment. Macrocells and small cell antennas can connect to a SeGW using a back haul (BH) network that may include one or more of, for example, the Internet, a private LAN, and/or an Alternative Access Vendor (AAV), to provide high-bandwidth data connections between cell sites (antennas) and the telecom core network, particularly for 4G and 5G networks. An inner IP address, which can be either static or dynamic, is then used for communication between the small cell and network core elements. This combination of using outer and inner IP addresses ensures secure communication between the small cell and the network core elements, such as the Mobility Management Entity (MME) in a 4G LTE core or the Session Management Function (SMF) and Access and Mobility Management Function (AMF) in a 5G core. Inner IP addresses may be assigned by the SeGW to a small cell as either static IP addresses or dynamic IP addresses. Moreover, secure communication may be established by encrypting the IP packets using Encryption & Integrity Algorithms negotiated during an Internet key exchange-security association (IKE-SA) exchange as part of an IPSec tunnel.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In contrast to prior solutions, one or more of the embodiments presented herein provide for a security gateway (SeGW) for use by a network access node (e.g., small cell base stations) to access an operator core network. According to some embodiments, an SeGW may include an adaptive internal tunnel address arbitrator for processing SeGW request messages (e.g., Internet Key Exchange (IKE)-authorization (AUTH) messages) from network access nodes. The adaptive internal tunnel address arbitrator provides a configurable option for an SeGW that may be used to control the inner tunnel network address assignment process to minimize the occurrence of dropped IPSec tunnels when an Internet protocol security remote access client (IRAC) authentication (e.g., based on certificates and/or pre-shared-keys (PSK)) is successful, but a requested static inner IP address could not be allocated to the access node. More specifically, in such cases where an SeGW cannot provide the access node with a requested static address, as long as the access node's certificate is validated as part of initializing an IPSec tunnel, then the adaptive internal tunnel address arbitrator may instead allocate an available dynamic inner IP address to the access node. As such, the adaptive internal tunnel address arbitrator advantageously facilitates maintaining a validly established IPSec tunnel by permitting the SeGW to assign a currently unassigned inner tunnel IP address to the small cell node from its pool of available dynamic IP addresses.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network operating environment with one or more security gateways comprising an adaptive internal tunnel address arbitrator, in accordance with some embodiments;

FIG. 2 is a diagram illustrating an example secure connectivity configuration between an access node and an operator core network, in accordance with some embodiments;

FIG. 3 is a diagram for an example data flow for establishing a secure connectivity configuration using an adaptive internal tunnel address arbitrator, in accordance with some embodiments;

FIG. 4A illustrates an example data flow where an adaptive internal tunnel address arbitrator allocates a requested static inner IP address to an access node, in accordance with some embodiments;

FIG. 4B illustrates an example data flow where an adaptive internal tunnel address arbitrator allocates a dynamic static inner IP address to an access node, in accordance with some embodiments;

FIG. 5 is a diagram illustrating an example telecommunications network environment comprising a network function for an adaptive internal tunnel address arbitrator, in accordance with some embodiments;

FIG. 6 is a flow chart illustrating an example method for an adaptive internal tunnel address arbitrator, according to some embodiments;

FIG. 7 is a diagram illustrating an example computing environment, in accordance with one embodiment; and

FIG. 8 is a diagram illustrating an example cloud computing environment, in accordance with some embodiments.

### DETAILED DESCRIPTION

Embodiments of the present disclosure provide for adaptive security gateway tunnel internal address arbitration for telecommunications systems and applications.

Presently, when a small cell node initializes and connects to a security gateway (SeGW) of a telecommunications network to attempt to reach the operator core network (OCN), the small cell node may authenticate itself using one or more IPSec certificates. Once the small cell node validates itself with the SeGW, an IPSec tunnel may be initialized and encrypted communications established using the respective outer tunnel IP addresses of the small cell node and the SeGW. The small cell node's initialization message to the SeGW may further include a request to be assigned an inner tunnel static IP address, through which the small cell node may then communicate with core network functions of the operator core network. Static IP allocations can be advantageous as they provide a consistent IP address for use by a small cell, aiding in seamless call handovers and troubleshooting. Static IP allocations may also aide in E-UTRAN New Radio-Dual Connectivity (ENDC)—a feature in 5G networks that allows mobile devices to connect to both 4G LTE and 5G NR (New Radio) networks simultaneously. When a small cell node requests a specific static inner IP address from the SeGW, the SeGW checks its pool of static inner IP addresses to determine if the requested static IP address is available. If the IP address is available (e.g., not already allocated to another network node), the SeGW may assign it to the requesting small cell node. In this way, a small cell node may consistently receive the same inner IP address upon each connection to the operator core network. However, static IP addresses present a challenge with respect to geo-redundancy strategies (e.g., strategies for placing physical servers in geographically diverse data centers to safeguard against catastrophic events) and during circumstances where the small cell node's default (e.g., local) SeGW is experiencing an outage or is otherwise unreachable. Typically, a small cell node is directed to first attempt to connect to a local SeGW (e.g., an SeGW that is closest physically or with respect to network hops) as its primary/preferred SeGW. When that preferred SeGW is not available, the small cell node may instead be directed to a secondary SeGW for access to the operator core network. However, when the small cell node sends its static inner IP address request to a secondary SeGW, that requested static inner IP may not be available from the secondary SeGW for allocation to the small cell node. For example, the requested static IP address may belong to a range of IP addresses assigned to its primary SeGW, but may be outside the range of IP addresses that are allocatable by the secondary SeGW. In that case, the secondary SeGW-being unable to honor the static IP request-will cause the termination of the IPSec tunnel with the small cell node.

In contrast to prior solutions such as described above, with one or more of the embodiments presented herein, a security gateway (SeGW) used by small cell nodes (and/or other network nodes) to access an operator core network may include an adaptive internal tunnel address arbitrator for processing SeGW request messages, such as Internet Key Exchange (IKE)-AUTH messages. The adaptive internal tunnel address arbitrator provides a configurable option for an SeGW that may be used to control the inner tunnel network address assignment process to minimize the occurrence of dropped IPSec tunnels when an Internet protocol security remote access client (IRAC) authentication (e.g., based on certificates and/or pre-shared-keys (PSK)) is successful, but a requested static inner IP address could not be allocated to the small cell node. More specifically, in such cases where an SeGW cannot provide the small cell node with the requested static address, as long as the small cell node's certificate is validated as part of the IPSec tunnel, the adaptive internal tunnel address arbitrator may instead allocate an available dynamic IP address to the small cell node. As such, the adaptive internal tunnel address arbitrator advantageously facilitates the IPSec tunnel to be allowed to come up (rather than being dropped) by permitting the SeGW to assign a currently unassigned inner tunnel IP address to the small cell node from its pool of available dynamic IP addresses.

In some embodiments, when a small cell node attempts to initiate a connection to the operator core network, the small cell node firsts obtains an IP address for the SeGW that it will use to securely access the operator core network. As an example, an SeGW may be implemented on an edge server of the operator core network accessible via a backhaul (BH) network (e.g., the Internet, private LAN, alternative access vendor (AAV), and/or other public or proprietary backhaul network) between the SeGW and the small cell node. The small cell node may send a query (e.g., for a SeGW fully qualified domain name (FQDN)) to a dynamic name server (DNS) that is configured to determine a location of the small cell node, and based on that location, provide the small cell node with the IP address of a nearest (or otherwise preferred) SeGW. In some embodiments, the DNS may be implemented as a Global Traffic Manager (GTM)-type DNS which functions to return DNS query responses at least partially based on an identity of the network node making the DNS query. As such, when the DNS receives the query from the small cell node, it may respond with an IP address of the SeGW currently designated as the preferred primary SeGW for that particular small cell node. Under nominal circumstances when the primary SeGW associated with a small cell node is up and running, the DNS would respond to a DNS query with the IP address of that primary SeGW. Since the primary SeGW operates as the preferred gateway for this small cell node, this SeGW will have access to a static inner IP address pool that includes the static inner IP address that the small cell node is programmed to automatically request. Moreover, in some embodiments the primary SeGW may hold that static inner IP address pool in reserve for this particular small cell node so that when the small cell node requests its static inner IP address, the SeGW will not have previously allocated that static inner IP address to another network node. When the small cell node requests its static inner IP address, that address should therefore be available to the primary SeGW from its static inner IP address pool for allocation to a small cell node so that the IPSec tunnel may be allowed to come up and an inner tunnel communication link established between the small cell node and the operator core network using the requested static inner IP address assigned to the small cell node.

That said, in some scenarios, the default preferred SeGW may be unavailable (e.g., due to planned maintenance or equipment outage). The DNS may be configured to maintain an availability status log of SeGWs so that when a small cell node requests an SeGW network address and its preferred SeGW is unavailable, the DNS may instead respond to the query with the IP address of another SeGW (e.g., a secondary SeGW) that is available. The small cell node may then use the provided IP address to initiate a connection (an IPSec tunnel connection) with the secondary SeGW by providing its certificate for validation and may communicate to the secondary SeGW its request to be allocated to its desired static inner IP address. However, in this case, the secondary SeGW-not being the small cell node's primary SeGW-may not have the requested static IP address available from its own static inner IP address pool for allocation to the small cell node. According to one or more embodiments of this disclosure, the adaptive internal tunnel address arbitrator may recognize the inability of the SeGW to allocate the requested static inner IP address and instead direct the SeGW to allocate to the small cell node, a dynamic inner IP address available from the secondary SeGW's dynamic inner IP address pool. The IPSec tunnel may thus be allowed to come up and an inner tunnel communication link established between the small cell node and the operator core network using the allocated dynamic inner IP address assigned to the small cell node by the secondary SeGW.

In some embodiments, when a small cell node is communicating with the operator core network via a secondary SeGW, a primary SeGW switch-over process may be periodically performed to determine whether the small cell node's primary SeGW has returned to service. For example, in some embodiments the adaptive internal tunnel address arbitrator of the secondary SeGW may periodically communicate with the DNS to determine when the primary SeGW is again available, and trigger the small cell node to perform a reconnect operation. The small cell node would be dropped by the secondary SeGW, and when it queries the DNS to perform a reconnect, it would be provided with the network address of its primary SeGW, which can then allocate the small cell node with its preferred static inner IP address. In some embodiments, the adaptive internal tunnel address arbitrator may operate a timeout clock that triggers the small cell node to perform the reconnect operation after a predetermined period of time (e.g., 24 hours) to attempt to reconnect to the primary SeGW, which can then allocate the small cell node with its preferred static inner IP address.

In some embodiments, the adaptive internal tunnel address arbitrator may leverage the payload structure of standard IKE-AUTH request and IKE-AUTH response messages to arbitrate between allocating static versus dynamic inner tunnel addresses to a small cell node.

As an example, when a small cell node is operating as an IPSec client to set up an IPSec tunnel with an SeGW, and is not requesting a static inner IP address allocation, it may communicate its ability to operate with a dynamic inner IP address allocation, by sending the SeGW a request (e.g., an IKE-AUTH request) that includes a populated (e.g., non-null) configuration payload field. When the adaptive internal tunnel address arbitrator detects the populated configuration payload field in the request message, that triggers the adaptive internal tunnel address arbitrator to cause the SeGW to pull a dynamic inner IP address allocation from its dynamic inner IP address pool, and provide the small cell node with a response (e.g., an IKE-AUTH response) that includes the assigned dynamic inner IP address. In some embodiments, the SeGW may populate the Configuration Payload and Traffic Selector Initiator (TSi) with the indication of an inner IP address (e.g., an IPv4 or IPv6 address) to communicate to the small cell node that it has been allocated a dynamic inner IP address for communicating with the operator core network.

When the small cell node is operating as an IPSec Client to set up an IPSec tunnel with an SeGW and is requesting a static inner IP address allocation, it may communicate its request to operate with a static inner IP address allocation by sending the SeGW a request (e.g., an IKE-AUTH request) that includes a non-populated (e.g., null) configuration payload field, and a Traffic Selector Payload that indicates the static inner IP address that the small cell node is requesting to be assigned. Here, adaptive internal tunnel address arbitrator may match the requested static inner IP address with the static inner IP address pool for this SeGW. If the SeGW is the primary SeGW for the requesting small cell node, then the requested static inner IP address should be available. The primary SeGW may assign the static inner IP address to the small cell node and set up the IPSec tunnel between the primary SeGW and the small cell node. The primary SeGW may send the small cell node a response (e.g., an IKE-AUTH response) that includes a non-populated (e.g., null) configuration payload field, and a Traffic Selector Initiator (TSi) populated with the indication of an IPv4 or IPv6 inner IP address, to communicate to the small cell node that it has been allocated the requested static inner IP address for communicating with the operator core network. Otherwise, when the SeGW is not the primary SeGW for the requesting small cell node (e.g., it is a secondary SeGW), then the requested static inner IP address may not be available from the static inner IP address pool. In this case, the adaptive internal tunnel address arbitrator may select an unallocated dynamic inner IP address from the dynamic inner IP address pool for this SeGW, assign the dynamic inner IP address to the small cell node, and set up the IPSec tunnel between the primary SeGW and the small cell node. The secondary SeGW may send the small cell node a response (e.g., an IKE-AUTH response) that includes a Configuration Payload and a Traffic Selector Payload populated with the indication of an IPv4 or IPv6 inner IP address to communicate to the small cell node that it has been allocated a dynamic inner IP address for communicating with the operator core network.

In some embodiments, a small cell node operating as an IPSec client may request setting up the IPSec tunnel using a request (e.g., an IKE-AUTH request) that has both Configuration Payload and Traffic Selector Payload (Initiator & Responder) populated. If the Traffic Selector Payload includes a Traffic Selector Initiator that indicates a static inner IP address, then the adaptive internal tunnel address arbitrator may give priority to this static inner IP address and match the requested static inner IP address with its static IP address pool list and assign the IP address to the small cell node if it is available. When the requested static inner IP address in the Traffic Selector Initiator matches an address listed in the static IP address pool, but that address is being used by another IPSec Client, when the requested static inner IP address in the Traffic Selector Initiator does not match an address listed in the static IP address pool, and/or where the Traffic Selector Initiator indicates IP addresses as all zeros (e.g., 0.0.0.0), then the adaptive internal tunnel address arbitrator may assign a dynamic inner IP address from the dynamic IP address pool as discussed above—to prevent the Security Gateway (SeGW) from dropping incoming IPSec tunnel requests from a small cell node as long as the client's certificates are successfully validated, which serves to reduce the downtime for IPSec Clients for high-priority projects (e.g., requiring 24-hours/7-days-a-week uptime) in cases where an INTERNAL ADDRESS FAILURE error would otherwise cause an IPSec tunnel with a small cell node to be dropped.

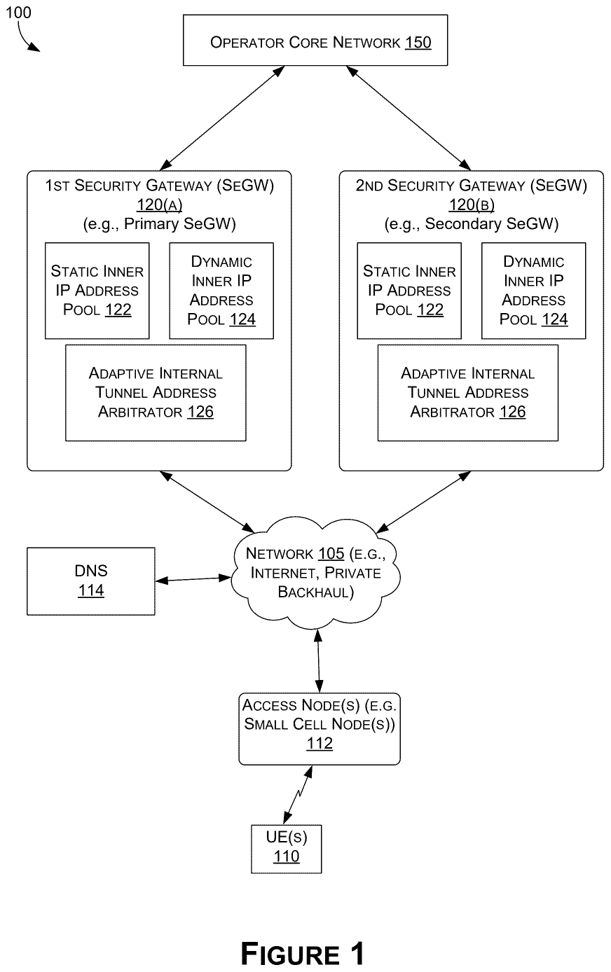

FIG. 1 is a diagram illustrating an example network operating environment 100, in accordance with some embodiments described herein. As shown in FIG. 1, operating environment 100 comprises one or more security gateways 120 (e.g., IPSec security gateways) through which secured access may be obtained to a telecommunication system's operator core network 150. For example, a telecommunications system access node 112 (e.g., a small cell base station) may provide an access point to one or more user equipment devices (shown as UE(s) 110) through which the UE(s) 110 may access network services made available by the operator core network 150, such as but not limited to, cellular communications services. For example, a UE 110 may comprise any form of computing device comprising such as, but not limited to, workstations, desktop computers, laptop computers, smart phones, tablets, handheld and/or wearable computing devices, personal digital assistants, a fitness tracker, or any other device capable of communicating using one or more resources of the operator core network 150. The terms “user equipment,” “UE,” and/or “user device” are used interchangeably to refer to a device employed by an end user that communicates using a network. UE(s) 110 may therefore include components such as software and hardware, one or more processors (e.g., processing circuitry), a memory, a display component, a power supply or power source, a speaker, a touch-input component, a keyboard, and the like. UE(s) 110 may comprise a wired or wireless network interface through which they communicate with the access node 112. The at least one network 105 may define a backhaul network through which connectivity between the access node 112 and one or more of the SeGWs 120 may be established to transport uplink communications from the UE(s) 110 to the operator core network 150 and/or transport downlink communications from the operator core network 150 to the UE(s) 110, and may be implemented using one or more networks such as the Internet, a private LAN, an alternative access vendor (AAV), and/or other public and/or proprietary backhaul network(s). In various embodiments, a telecommunications system access node 112 may comprise any form of network access device and/or network node such as, but not limited to, a small cell base station (shown as access node 112 in FIG. 1), a base station router (e.g., a radio access network (RAN) router), a customer premise equipment (CPE) gateway, or other network access device. The access node 112 may operate using any form or combination of wired or wireless communication network technology including, but not limited to, a cellular communications network (e.g., a 5G telecommunications network), and/or one or more prior access technology networks (e.g., 4G Long-Term Evolution (LTE)).

As shown in FIG. 1, in some embodiments, network operating environment 100 includes one or more dynamic name servers (DNS(s)) 114. The access node 112 may send a query to the DNS(s) 114 to obtain an IP address for a nearest (or otherwise preferred) SeGW 120 with which the access node 112 can establish a secure tunnel for accessing the operator core network 150. The DNS(s) 114 may be configured to determine a location of the access node 112, and based on that location, provide the access node 112 with the IP address of an SeGW 120. In some embodiments, a DNS 114 may be implemented as a Global Traffic Manager (GTM)-type DNS which functions to return DNS query responses at least partially based on an identity of the network node making the DNS query. As such, when the DNS 114 receives the SeGW address query from the access node 112, it may respond with an IP address of the SeGW 120 currently designated as the preferred primary SeGW for that particular access node 112 when that primary SeGW is available.

As is also shown in FIG. 1, the network operating environment 100 may include a plurality of SeGWs 120, which includes an SeGW 120(a) that is assigned to operate as the primary SeGW 120(a) for access node 112, and one or more secondary SeGWs 120(b) that the access node 112 may be directed to by the DNS 114 when the primary SeGW 120(a) becomes unavailable. It should be noted that an SeGW 120 that functions as the primary SeGW for one access node 112 may serve as a secondary SeGW for another access node 112. As previously discussed, according to embodiments of this disclosure, one or more (up to each) of the SeGWs 120 may include an adaptive internal tunnel address arbitrator 126, a static inner IP address pool 122, and a dynamic inner IP address pool 124.

The adaptive internal tunnel address arbitrator 126 provides a configurable option for an SeGW 120 that may be used to control the inner tunnel network address assignment process to minimize the occurrence of dropped IPSec tunnels when an IRAC authentication with an access node 112 is successful, but a requested static inner IP address could not be allocated to the access node 112. More specifically, in such cases where an SeGW 120 cannot provide the small cell node with the requested static address from its static inner IP address pool 122, as long as the small cell node's certificate is validated as part of the IPSec tunnel, the adaptive internal tunnel address arbitrator 126 may instead allocate an available dynamic IP address to the access node 112 from the dynamic inner IP address pool 124. As such, the adaptive internal tunnel address arbitrator 126 advantageously facilitates the IPSec tunnel to be allowed to come up rather than dropping it by permitting an SeGW 120 to assign a currently unassigned dynamic inner tunnel IP address to the access node 112.

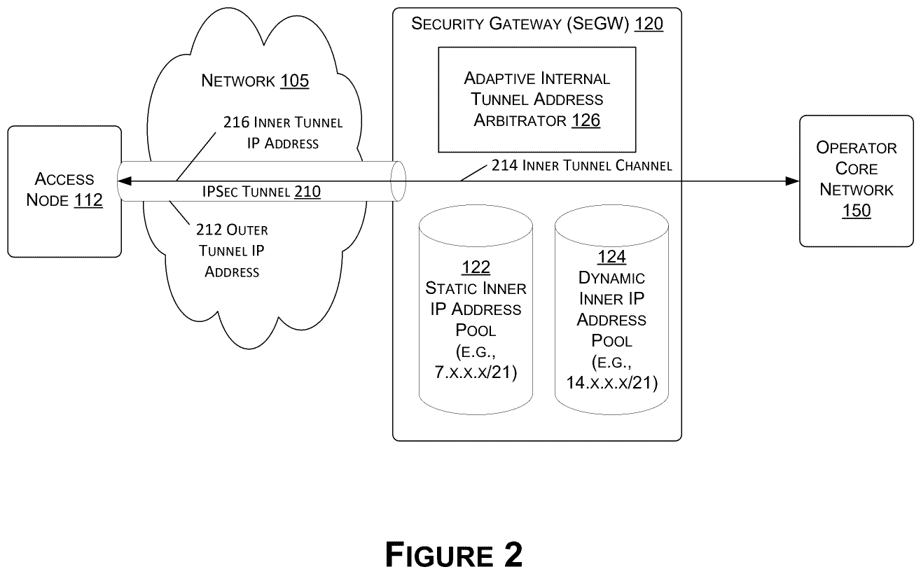

FIG. 2 is a diagram illustrating an example secure connectivity configuration between an access node 112 and the operator core network 150. In this example, an IPSec tunnel 210 provides a corridor for secured/encrypted communication between the access node 112 and the SeGW 120. Outside the IPSec tunnel 210, the access node 112 is allocated an outer tunnel IP address 212 that provides the access node 112 with a network address with respect to communications via network 105. Through the IPSec tunnel 210, the SeGW 120 establishes an inner tunnel channel 214 between the access node 112 and operator core network, assigning an inner tunnel IP address 216 to the access node that identifies the access node 112 within the context of communicating with the various network functions of the operator core network 150. As shown in FIG. 2, the SeGW comprises the adaptive internal tunnel address arbitrator 126 and may include one or more address pools (e.g., databases) that include the static inner IP address pool 122 and the dynamic inner IP address pool 124. The static inner IP address pool 122 includes a range of IP addresses (e.g., a 7.x.x. x/21 range of IP addresses) from which the adaptive internal tunnel address arbitrator 126 may be allocated to an access node 112 that requests a static inner IP address for the inner tunnel IP address 216. The dynamic inner IP address pool 124 includes a range of IP addresses (e.g., a 14.x.x. x/21 range of IP addresses) from which the adaptive internal tunnel address arbitrator 126 may allocate to an access node 112 when the access node's request for a static inner IP address cannot be granted. The IPSec tunnel 210 provides for the encryption of communications traffic (e.g., uplink and downlink user plane data and/or control plane channels) transported on the inner tunnel channel 214 between the access node 112 and the SeGW 120. Communications traffic transported on the inner tunnel channel 214 between the SeGW 120 and operator core network 150 need not be encrypted as the telecommunications network within the security boundary provided by the SeGW 120 is a secure environment.

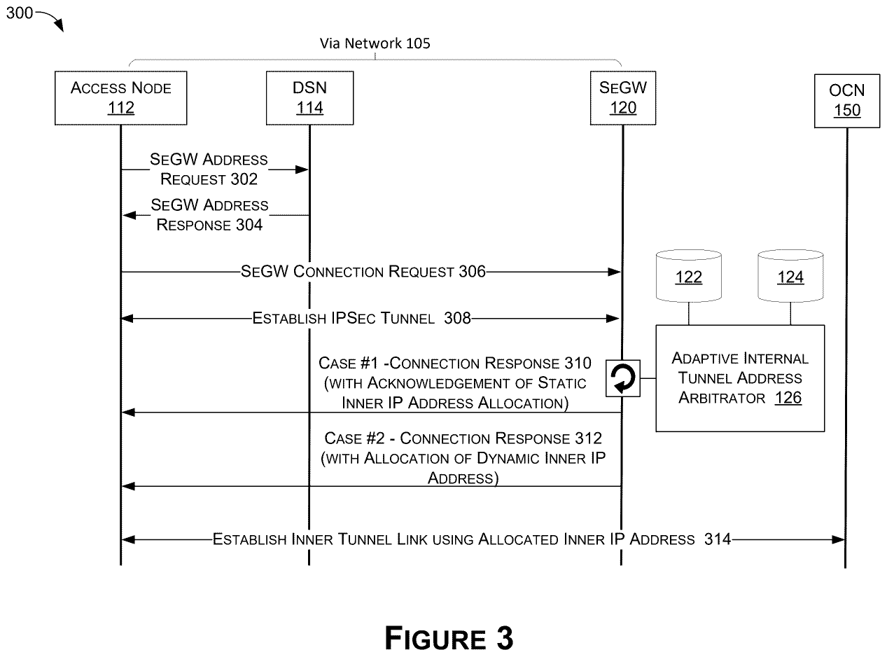

The data flow for establishing the secure connectivity configuration shown in FIG. 2 may be described more particularly with respect to the example data flow diagram 300 illustrated in FIG. 3. As shown starting with FIG. 3 at 302, an access node 112 may initiate establishing a connection with an SeGW 120 by sending an SeGW address request to the DNS 114. The access node 112 may send the SeGW address request 302 query to the DNS(s) 114 to obtain an IP address for a nearest (or otherwise preferred) SeGW 120 with which the access node 112 can establish a secure tunnel for accessing the operator core network 150. The DNS(s) 114 may be configured to determine a location of the access node 112, and based on that location, provide an SeGW address response 304 to the access node 112 that includes the IP address of an SeGW 120.

Given the IP address of the SeGW 120, the access node 112 may send an SeGW connection request 306 to the SeGW 120 (e.g., an IKE-AUTH request), which may include authentication data (e.g., a certificate) for authenticating the access node 112 with SeGW 120. Based on a successful authentication of the access node 112, the SeGW 120 may establish an IPSec tunnel (shown at 308) between the SeGW 120 and the access node 112—such as the IPSec tunnel 210 shown in FIG. 2. A discussed herein, the SeGW connection request 306 may also indicate that the access node 112 requests allocation of a specific static inner IP address (e.g., for communicating via the inner tunnel channel 214).

Based on the static inner IP address specified in the SeGW connection request 306, the adaptive internal tunnel address arbitrator 126 may query static inner IP address pool 122 to determine if the static inner IP address pool 122 has a matching static inner IP address that is available for allocation to the requesting access node 112.

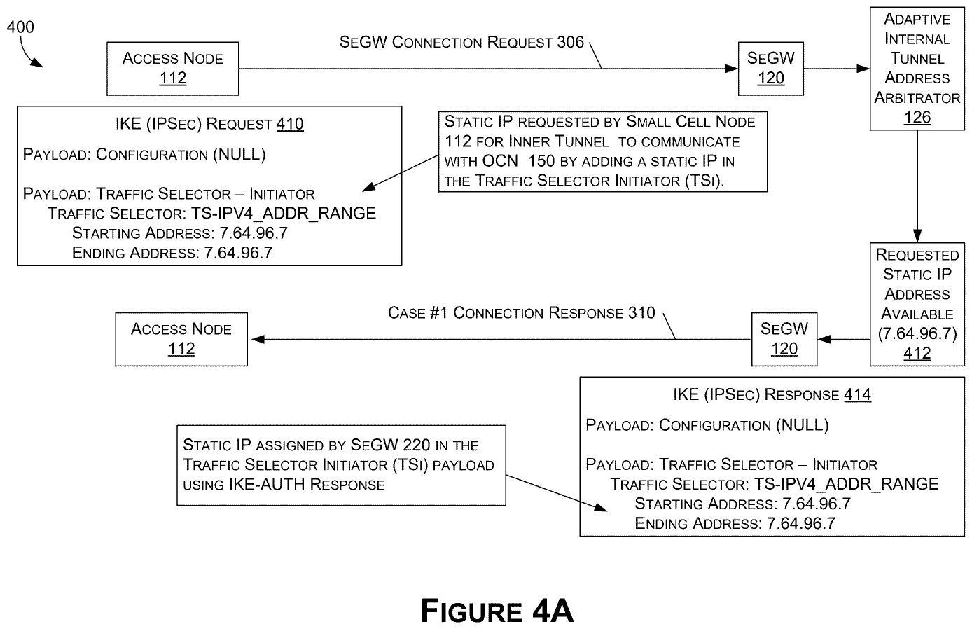

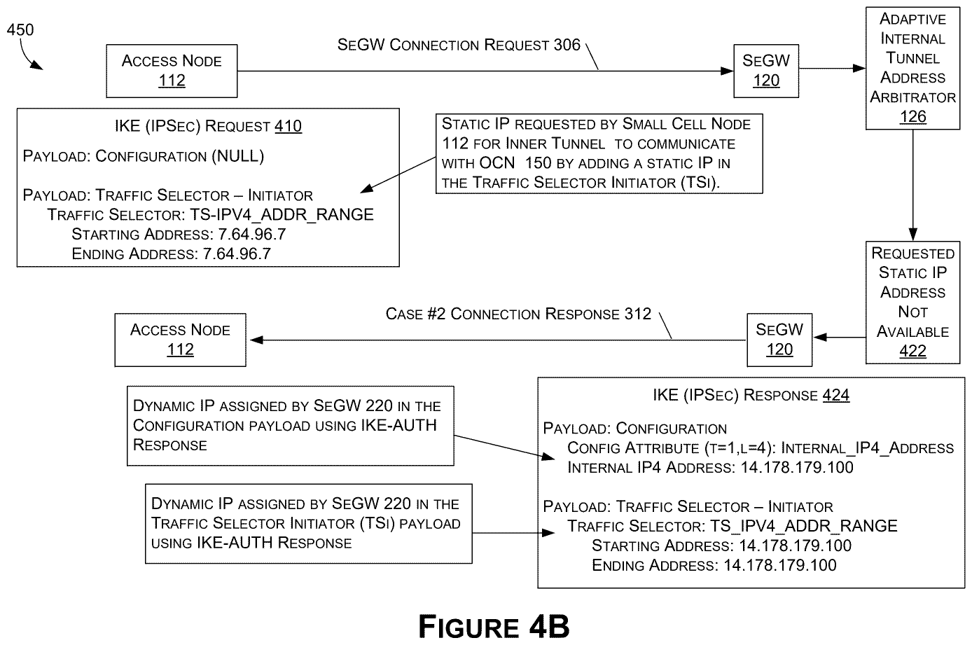

For the case where the static inner IP address pool 122 has a matching static inner IP address that is available for allocation to the requesting access node 112, then the adaptive internal tunnel address arbitrator 126 may trigger the SeGW 120 to send a connection response 310 to the access node 112 that includes an acknowledgement of the allocation of the requested static inner IP address to the access node. For example, FIG. 4A at 400 illustrates the example case where the adaptive internal tunnel address arbitrator 126 is able to allocate to the access node 112 the requested static inner IP address. In some embodiments, the access node 112 may transmit an SeGW connection request 306 to the SeGW (e.g., an IKE-AUTH request) that comprises one or more payload fields as shown at 410. The access node 112 may communicate a request for a static inner IP address allocation by sending an SeGW connection request 306 that includes a non-populated (e.g., null) configuration payload field, and a traffic selector payload that indicates the static inner IP address that the access node 112 is requesting to be assigned. The adaptive internal tunnel address arbitrator 126 may process (e.g., parse) the SeGW connection request 306 and identify the non-populated (e.g., null) configuration payload field and the static inner IP address included in the TSi, and interpret that payload configuration as a request for the static IP address indicated by the traffic selector payload. The adaptive internal tunnel address arbitrator 126 may query the static inner IP address pool 122 to determine if it includes a matching static inner IP address that is available for allocation to the requesting access node 112. If the static inner IP address is available for allocation to the requesting access node 112 (shown at 412), then the adaptive internal tunnel address arbitrator 126 may trigger the SeGW 120 to send a connection response 310 to the access node 112 that includes an acknowledgement of the allocation of the requested static inner IP address. For example, the SeGW 120 may send the access node 112 a connection response 310 (e.g., an IKE-AUTH response) such as shown at 414 that includes a non-populated (e.g., null) configuration payload field, and a traffic selector payload populated with an inner IP address indicating the same static inner IP address requested by the access node 112 in the traffic selector payload of the SeGW connection request 306.

For the case where the static inner IP address pool 122 does not have a matching static inner IP address that is available for allocation to the requesting access node 112, then the adaptive internal tunnel address arbitrator 126 may instead trigger the SeGW 120 to send a connection response 312 to the access node 112 that includes a dynamic inner IP address obtained from the dynamic inner IP address pool 124. In this case, the adaptive internal tunnel address arbitrator 126 may select an unallocated dynamic inner IP address from the dynamic inner IP address pool 124 for this SeGW 120, and assign the dynamic inner IP address to the access node 112 while maintaining the IPSec tunnel between the access node 112 and the SeGW 120.

For example, FIG. 4B illustrates at 450 the example case where the adaptive internal tunnel address arbitrator 126 is not able to allocate to the access node 112 the requested static inner IP address. In some embodiments, the access node 112 may transmit the SeGW connection request 306 to the SeGW (e.g., an IKE-AUTH request) that comprises one or more payload fields as shown at 410. The access node 112 may communicate a request for the static inner IP address allocation by sending an SeGW connection request 306 that includes a non-populated (e.g., null) configuration payload field, and a traffic selector payload that indicates the static inner IP address that the access node 112 is requesting to be assigned. The adaptive internal tunnel address arbitrator 126 may process (e.g., parse) the SeGW connection request 306 and identify the non-populated (e.g., null) configuration payload field and the static inner IP address included in the traffic selector payload, and interpret that payload configuration as a request for the static IP address indicated by the traffic selector payload. The adaptive internal tunnel address arbitrator 126 may query the static inner IP address pool 122 to determine if it includes a matching static inner IP address that is available for allocation to the requesting access node 112. If the static inner IP address pool 122 does not indicate that the requested static inner IP address is available for allocation (shown at 442), then the adaptive internal tunnel address arbitrator 126 may trigger the SeGW 120 to send a connection response 312 to the access node 112 that includes an allocation of a dynamic inner IP address obtained from the dynamic inner IP address pool 124. For example, the SeGW 120 may send the access node 112 a connection response 312 (e.g., an IKE-AUTH response) such as shown at 424 that includes a configuration payload and a TSi payload, both populated with the indication of the allocated dynamic inner IP address.

In each case, whether the connection response indicates that allocation of the requested static inner IP address, or the allocation of an available dynamic inner IP address, the IPSec tunnel 210 can be maintained and the access node 112 may establish the inner tunnel channel 214 with the operator core network 150, as shown at 314. As such, the adaptive internal tunnel address arbitrator 126 advantageously facilitates the IPSec tunnel 210 to be maintained rather than dropped, by permitting the SeGW 120 to assign a currently unassigned inner tunnel IP address to the access node 112 from its pool of available dynamic IP addresses 124.

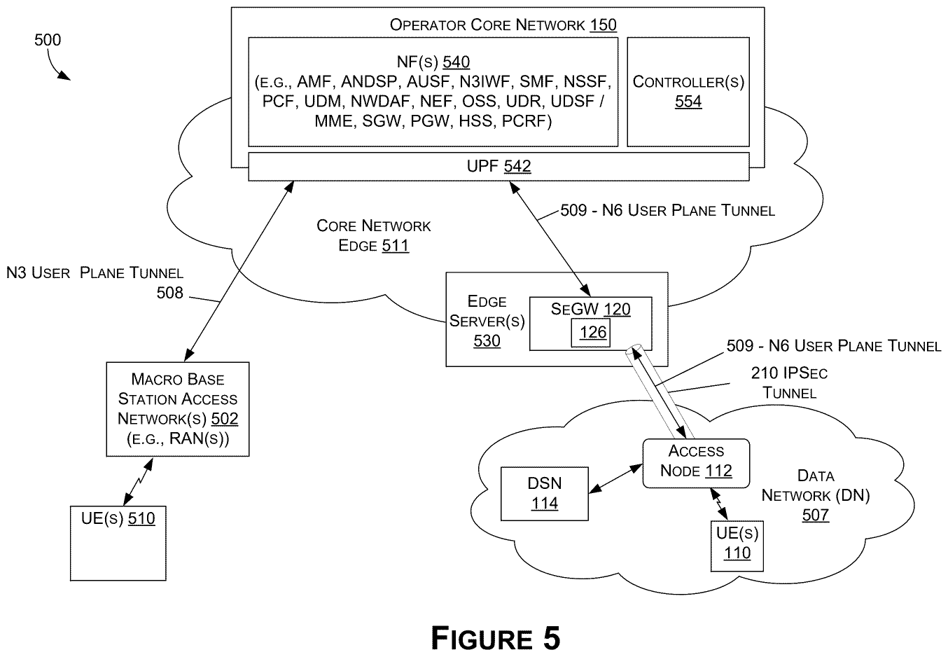

Referring now to FIG. 5, FIG. 5 is a diagram illustrating an example telecommunications network environment comprising an SeGW 120 that includes an adaptive internal tunnel address arbitrator 126. In some embodiments, the adaptive internal tunnel address arbitrator 126 may be implemented as a network function that is made available as a network service. For example, in some embodiments, the adaptive internal tunnel address arbitrator 126 may respond to application programming interface (API) calls from an access node 112 to activate the ability to be allocated a dynamic inner IP address when a requested static IP address is otherwise not available. Network environment 500 is but one example of a suitable telecommunications network and is not intended to suggest any limitation as to the scope of use or functionality of the embodiments disclosed herein, and nor should the network environment be interpreted as having any dependency or requirement relating to any one or combination of components illustrated.

As shown in FIG. 5, network environment 500 comprises an operator core network 150 (also referred to as a “core network”) that provides one or more network services to one or more UEs 510 via at least one macro base station access network 502 (e.g., a radio access network (RAN)) and/or one or more UEs 110 via the access node 112. In some embodiments, network environment 500 comprises, at least in part, a wireless communications network, such as, but not limited to, a 4G wireless communications network and/or a 5G wireless communications network. In some embodiments, the access network(s) 502 of network environment 500 comprises one or more RANs, which may be referred to in the context of a wireless telecommunications network as a wireless base station, cell site, or cellular base station. At least one RAN may represent at least one wireless base station coupled to the operator core network 150 to establish one or more communication links between the operator core network 150 and UE 510. Each RAN may provide wireless connectivity access to one or more UEs 510 operating within one or more coverage areas associated with a particular RAN. The RAN may implement wireless connectivity using, for example, 3rd Generation Partnership Project (3GPP) technologies. The one or more of the access network(s) 502 may be referred to as an eNodeB in the context of a 4G Long-Term Evolution (LTE) implementation, a gNodeB in the context of a 5G New Radio (NR) implementation, or other terminology depending on the specific implementation technology. In some embodiments, access networks 502 may comprise, at least in part, components of a customer premises network, such as a distributed antenna system (DAS), for example. When an access network 502 is implemented as a RAN, the RAN may comprise a multimodal network (for example, comprising one or more multimodal access devices) where multiple radios supporting different systems are integrated into the RAN. Such a multimodal access network may support a combination of 3GPP radio technologies (e.g., 4G, 5G, and/or 6G) and/or non-3GPP radio technologies (e.g., Institute of Electrical and Electronics Engineers (IEEE) 802.11 (WiFi) and/or IEEE 802.15 (Bluetooth) access points). In some embodiments, access network(s) 502 may comprise a terrestrial wireless communications base station and/or may be at least in part implemented as a space-based access network, such as a base station implemented by an Earth-orbiting satellite. Individual UEs 510 may communicate with the operator core network 150 via the access network(s) 502 over one or both of uplink (UL) radio frequency (RF) signals and downlink (DL) radio frequency (RF) signals.

As shown in FIG. 5, access networks 502 may be coupled to the operator core network 150 via a core network edge 511 that comprises edge server nodes and wired and/or wireless network connections that may further include wireless relays and/or repeaters. In some embodiments, the access networks 502 may be coupled to the operator core network 150 at least in part by a backhaul network such as the Internet or other public or private network infrastructure.

Core network edge 511 may comprise one or more network nodes (e.g., servers) or other elements of the operator core network 150 that may define the boundary of the operator core network 150 and may serve as the architectural demarcation point where the operator core network 150 connects to other networks such as, but not limited to, access networks 502, the Internet, a Data Network (DN) 507, and/or other third-party networks. In some embodiments, DN 507 may include one or more data stores and/or one or more cloud-based servers such that UE 510 and/or UE 110 may access services and/or content provided by the data store(s) and/or server(s) of DN 507. In some embodiments, an access node 112 and/or DNS 114 may be network nodes or elements within the DN 507 and/or may be coupled to the operator core network 150 at least in part by a backhaul network such as the Internet or other public or private network infrastructure.

In some embodiments, the network edge 511 may comprise one or more network nodes that include at least one edge server 530 that hosts an SeGW 120 as discussed herein. One or more edge server(s) 530 may provide, for example, edge-based network function services to UEs 110 and/or UEs 510 that may be accessed separately from services provided by network functions of the operator core network 150. For example, edge server(s) 530 may host databases, caches, microservices, ledgers, decentralized applications (e.g., DApps), and/or may perform data traffic monitoring, inspections, and/or aggregation for other network functions of the network environment 500. As shown in FIG. 5, an SeGW 120 instance executed by an edge server 530 may include the adaptive internal tunnel address arbitrator 126. In some embodiments, the SeGW 120 may be implemented on a computing device 700 and/or cloud computing environment 810 as discussed herein.

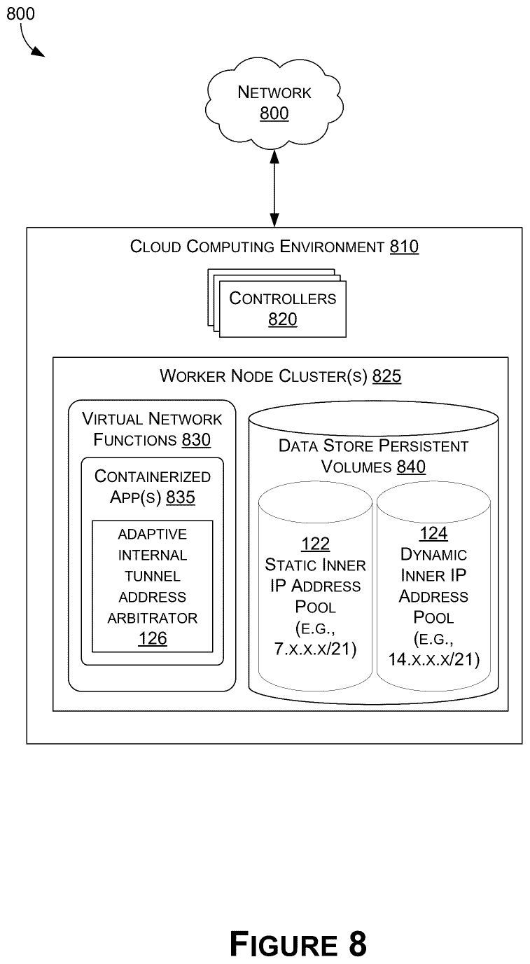

It should be understood that in some aspects, the network environment 500 may not comprise a distinct operator core network 150, but rather may implement one or more features of the operator core network 150 within other portions of the network, or may not implement them at all, depending on various carrier preferences. In some implementations, the operator core network 150 may comprise modules, also referred to as network functions (NFs), implemented by one or more processors and generally represented in FIG. 5 as NF(s) 540. Within the context of a 5G operator core network 150, such network functions 540 may include one or more of, but are not limited to, a core access and mobility management function (AMF), an access network discovery and selection policy (ANDSP), an authentication server function (AUSF), a user plane function (UPF), non-3GPP interworking function (N3IWF), a session management function (SMF), a network slice selection function (NSSF), a policy control function (PCF), a unified data management (UDM) function, a unified data repository (UDR), an unstructured data storage function (UDSF), a network data analytics function (NWDAF), a network exposure function (NEF), an operations support system (OSS), and/or other network functions. Within the context of a 4G operator core network 150, the network functions 540 may include on or more of, but not limited to, a serving gateway (SGW), packet data network gateway (PGW), policy control and charging rules function (PCRF), home subscription server (HSS), Mobility Management Entity (MME), and/or other network core elements. Implementation of these NFs 540 of the operator core network 150 may be executed by one or more controllers 554 on which these network functions are orchestrated or otherwise configured to execute utilizing processors and memory of the one or more controllers 554. The NFs may be implemented as physical and/or virtual network functions, container network functions, and/or cloud-native network functions, such as is described with respect to FIG. 8.

The user plane function (UPF), illustrated in FIG. 5 at 542, represents at least one function of the operator core network 150 that may extend into the core network edge 511. In some embodiments, the access network 502 is coupled to the UPF 542 within the core network edge 511 by a communication link that includes an N3 user plane tunnel 508. For example, the N3 user plane tunnel 508 may connect a cell site router of the access network 502 to an N3 interface of the UPF 542. The data store(s), server(s), and/or other elements of DN 507 (including, for example, access node 112) may be coupled to the UPF 542 in the core network edge 511 by an N6 user plane tunnel 509. For example, the N6 user plane tunnel 509 may connect a network interface (e.g., a switch, router, and/or gateway) of the DN 507 to an N6 interface of the UPF 542.

In some embodiments, user plane data may be communicated between the access node 112 and the user plane function 542 of the operator core network 150 based at least on the inner tunnel network address allocated to the access node 112 by the adaptive internal tunnel address arbitrator 126. In some embodiments, the operator core network 150 may comprise a plurality of UPFs 542, such as a UPF at the operator core network 150 and a UPF at the core network edge 511. For example, a UPF at the core network edge 511 may be used for local breakout and/or low-latency types of applications via an N9 interface between the distinct UPFs.

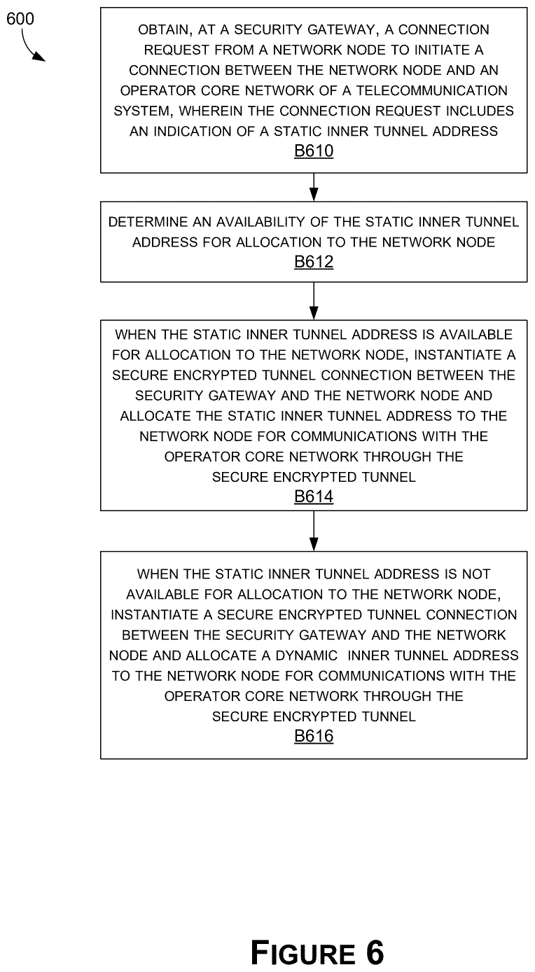

FIG. 6 is a flow chart illustrating a method 600 for an adaptive internal tunnel address arbitrator, according to some embodiments. It should be understood that the features and elements described herein with respect to the method of FIG. 6 may be used in conjunction with, in combination with, or substituted for elements of any of the other embodiments discussed herein and vice versa. Further, it should be understood that the functions, structures, and other descriptions of elements for embodiments described in FIG. 6 may apply to like or similarly named or described elements across any of the figures and/or embodiments described herein and vice versa. In some embodiments, elements of method 600 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 600 may be implemented by components of a telecommunications network environment 500, such as illustrated by FIG. 5.

The method 600, at B610, includes obtaining, at a security gateway, a connection request from a network node to initiate a connection between the network node and an operator core network of a telecommunication system, wherein the connection request includes an indication of a static inner tunnel address. In some embodiments, the network node comprises at least one of: a small cell base station, a customer premises equipment gateway, and a cellular base station router. The network node may be coupled to the security gateway through one or more of: the Internet, a backhaul internet protocol (IP), or a proprietary backhaul network.

For example, as shown in FIG. 1, a telecommunications system access node 112 (e.g., a small cell base station) may provide an access point to one or more user equipment devices (shown as UE(s) 110) through which the UE(s) 110 may access network services made available by the operator core network 150, such as but not limited to, cellular communications services. A network operating environment 100 may include a plurality of SeGWs 120, which includes an SeGW 120(a) that is assigned to operate as the primary SeGW 120(a) for an access node 112, and one or more secondary SeGWs 120(b) that the access node 112 may be directed to by the DNS 114 when the primary SeGW 120(a) becomes unavailable. It should be noted that an SeGW 120 that functions as the primary SeGW for one access node 112 may serve as a secondary SeGW for another access node 112. As previously discussed, according to embodiments of this disclosure, one or more (up to each) of the SeGWs 120 may include an adaptive internal tunnel address arbitrator 126, a static inner IP address pool 122, and a dynamic inner IP address pool 124. In some embodiments, network operating environment 100 includes one or more dynamic name servers (DNS(s)) 114. The access node 112 may send a query to the DNS(s) 114 to obtain an IP address for a nearest (or otherwise preferred) SeGW 120 with which the access node 112 can establish a secure tunnel for accessing the operator core network 150. The DNS(s) 114 may be configured to determine a location of the access node 112, and based on that location, provide the access node 112 with the IP address of an SeGW 120. In some embodiments, a DNS 114 may be implemented as a Global Traffic Manager (GTM)-type DNS, which functions to return DNS query responses at least partially based on an identity of the network node making the DNS query. As such, when the DNS 114 receives the SeGW address query from the access node 112, it may respond with an IP address of the SeGW 120 currently designated as the preferred primary SeGW for that particular access node 112 when that primary SeGW is available. In some embodiments, the security gateway may be implemented on an edge server of the operator core network. For example, as shown in FIG. 5, in some embodiments, a network edge 511 may comprise one or more network nodes that include at least one edge server 530 that hosts an SeGW 120, as discussed herein. One or more edge server(s) 530 may provide, for example, edge-based network function services to UEs 110 and/or UEs 510 that may be accessed separately from services provided by network functions of the operator core network 150.

The method 600, at B612, includes determining an availability of the static inner tunnel address for allocation to the network node. As previously discussed, according to embodiments of this disclosure, one or more (up to each) of the SeGWs 120 may include an adaptive internal tunnel address arbitrator 126, a static inner IP address pool 122, and a dynamic inner IP address pool 124. As shown in FIG. 2, the SeGW comprises the adaptive internal tunnel address arbitrator 126 and may include one or more address pools (e.g., databases) that include the static inner IP address pool 122 and the dynamic inner IP address pool 124. The static inner IP address pool 122 includes a range of IP addresses (e.g., a 7.x.x. x/21 range of IP addresses) from which the adaptive internal tunnel address arbitrator 126 may be allocated to an access node 112 that requests a static inner IP address for the inner tunnel IP address 216. The dynamic inner IP address pool 124 includes a range of IP addresses (e.g., a 14.x.x. x/21 range of IP addresses) from which the adaptive internal tunnel address arbitrator 126 may allocate to an access node 112 when the access node's request for a static inner IP address cannot be granted.

As shown starting with FIG. 3 at 302, an access node 112 may initiate establishing a connection with an SeGW 120 by sending an SeGW address request to the DNS 114. Given the IP address of the SeGW 120, the access node 112 may send an SeGW connection request 306 to the SeGW 120 (e.g., an IKE-AUTH request), which may include authentication data (e.g., a certificate) for authenticating the access node 112 with SeGW 120. In some embodiments, the secured encrypted tunnel connection may comprise an IPSec tunnel. For example, based on a successful authentication of the access node 112, the SeGW 120 may establish an IPSec tunnel (shown at 308) between the SeGW 120 and the access node 112—such as the IPSec tunnel 210 shown in FIG. 2. Thus, the method may include instantiating the secure encrypted tunnel connection in response to an authentication of the network node with the security gateway.

The method 600, at B614, includes when the static inner tunnel address is available for allocation to the network node, instantiating a secure encrypted tunnel connection between the security gateway and the network node and allocating an inner tunnel network address comprising the static inner tunnel address to the network node for communications with the operator core network through the secure encrypted tunnel. In some embodiments, the connection request may comprise an IKE request message comprising a payload traffic selector data field comprising an indication of the static network address. The security gateway determines the availability of the static inner tunnel address for allocation to the network node based on correlating the static inner tunnel address with a static address pool. For example, as discussed with respect to FIG. 4A, the adaptive internal tunnel address arbitrator 126 may determine if the SeGW 120 is able to allocate to the access node 112 the requested static inner IP address. The access node 112 may transmit an SeGW connection request 306 to the SeGW (e.g., an IKE-AUTH request) that comprises one or more payload fields as shown at 410. The access node 112 may communicate a request for a static inner IP address allocation by sending an SeGW connection request 306 that includes a non-populated (e.g., null) configuration payload field, and a traffic selector payload that indicates the static inner IP address that the access node 112 is requesting to be assigned. The adaptive internal tunnel address arbitrator 126 may process (e.g., parse) the SeGW connection request 306 and identify the non-populated (e.g., null) configuration payload field and the static inner IP address included in the traffic selector payload, and interpret that payload configuration as a request for the static IP address indicated by the traffic selector payload. The adaptive internal tunnel address arbitrator 126 may query the static inner IP address pool 122 to determine if it includes a matching static inner IP address that is available for allocation to the requesting access node 112. If the static inner IP address is available for allocation to the requesting access node 112 (shown at 412), then the adaptive internal tunnel address arbitrator 126 may trigger the SeGW 120 to send a connection response 310 to the access node 112 that includes an acknowledgement of the allocation of the requested static inner IP address. For example, the SeGW 120 may send the access node 112 a connection response 310 (e.g., an IKE-AUTH response) such as shown at 414 that includes a non-populated (e.g., null) configuration payload field, and a traffic selector payload populated with an inner IP address indicating the same static inner IP address requested by the access node 112 in the traffic selector payload of the SeGW connection request 306.

The method 600, at B616, includes when the static inner tunnel address is not available for allocation to the network node, instantiating the secure encrypted tunnel connection between the security gateway and the network node, and allocating the inner tunnel network address comprising a dynamic inner tunnel address to the network node for communications with the operator core network through the secure encrypted tunnel connection. In some embodiments, when the static inner tunnel address is determined to be unavailable for allocation to the network node, the security gateway allocates the dynamic inner tunnel address from a dynamic address pool. In some embodiments, when the static inner tunnel address is not available for allocation to the network node, the method may include communicating the dynamic inner tunnel address to the network node based on a connection response message comprising a payload traffic selector data field and a payload configuration data field indicating the dynamic inner tunnel address.

For example, FIG. 4B illustrates the example case where the adaptive internal tunnel address arbitrator 126 is not able to allocate to the access node 112 the requested static inner IP address. In some embodiments, the access node 112 may transmit the SeGW connection request 306 to the SeGW (e.g., an IKE-AUTH request) that comprises one or more payload fields as shown at 410. The access node 112 may communicate a request for the static inner IP address allocation by sending an SeGW connection request 306 that includes a non-populated (e.g., null) configuration payload field, and a TSi payload that indicates the static inner IP address that the access node 112 is requesting to be assigned. The adaptive internal tunnel address arbitrator 126 may process (e.g., parse) the SeGW connection request 306 and identify the non-populated (e.g., null) configuration payload field and the static inner IP address included in the traffic selector payload, and interpret that payload configuration as a request for the static IP address indicated by the traffic selector payload. The adaptive internal tunnel address arbitrator 126 may query the static inner IP address pool 122 to determine if it includes a matching static inner IP address that is available for allocation to the requesting access node 112. If the static inner IP address pool 122 does not indicate that the requested static inner IP address is available for allocation (shown at 422), then the adaptive internal tunnel address arbitrator 126 may trigger the SeGW 120 to send a connection response 312 to the access node 112 that includes an allocation of a dynamic inner IP address obtained from the dynamic inner IP address pool 124. For example, the SeGW 120 may send the access node 112 a connection response 312 (e.g., an IKE-AUTH response) such as shown at 424 that includes a configuration payload and a traffic selector payload both populated with the indication of the allocated dynamic inner IP address.

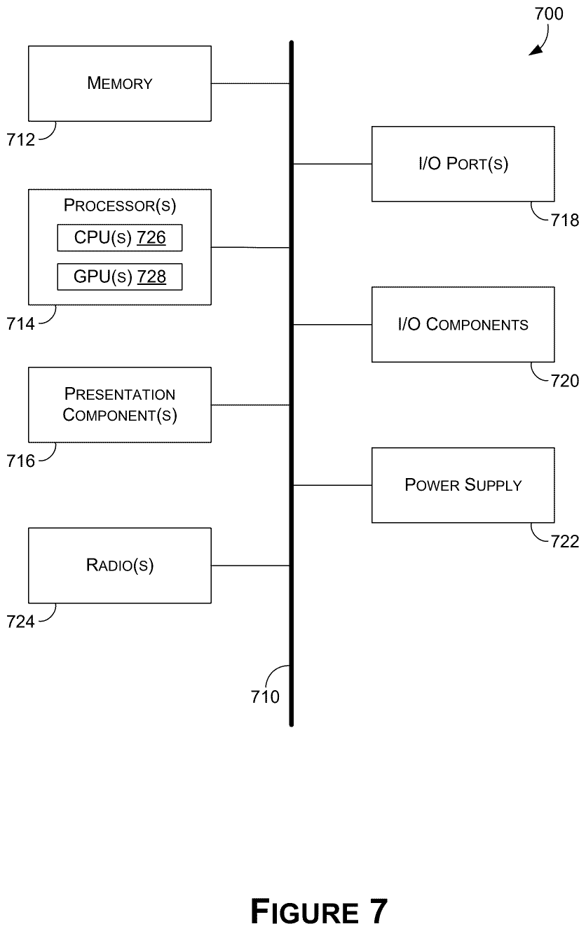

Referring to FIG. 7, a diagram is depicted of an exemplary computing environment suitable for use in implementations of the present disclosure. In particular, the exemplary computer environment is shown and designated generally as computing device 700. Computing device 700 is but one example of a suitable computing environment and is not intended to suggest any limitation as to the scope of use or functionality of the embodiments described herein, and nor should computing device 700 be interpreted as having any dependency or requirement relating to any one or combination of components illustrated. In various embodiments, one or more aspects of an SeGW 120 and/or adaptive internal tunnel address arbitrator 126 may be implemented at least in part using a computing device 700.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, computing device 700 includes bus 710 that directly or indirectly couples the following devices: memory 712, one or more processors 714, one or more presentation components 716, input/output (I/O) ports 718, I/O components 720, power supply 722, and radio 724. Bus 710 represents what may be one or more buses (such as an address bus, data bus, or combination thereof). The devices of FIG. 7 are shown with lines for the sake of clarity. However, it should be understood that the functions performed by one or more components of the computing device 700 may be combined or distributed amongst the various components. For example, a presentation component such as a display device may be one of I/O components 720. In some embodiments, one or more functions of an SeGW 120 and/or adaptive internal tunnel address arbitrator 126 may be executed at least in part by computing device 700. The processors 714 of computing device 700 may include a memory. The present disclosure hereof recognizes that such is the nature of the art, and reiterates that FIG. 7 is merely illustrative of an exemplary computing environment that can be used in connection with one or more implementations of the present disclosure. Distinction is not made between such categories as “workstation,” “server,” “laptop,” “handheld device,” “smart television,” etc., as all are contemplated within the scope of FIG. 7 and refer to “computer” or “computing device.”

Computing device 700 typically includes a variety of one or more computer-readable media storing computer-usable instructions. For example, applications, algorithms, and/or neural networks may be stored in a memory comprising such computer-readable media. Computer-readable media can be any available media that can be accessed by computing device 700 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient random-access memory (RAM), read-only memory (ROM), electrically erasable programmable read-only memory (EEPROM), flash memory or other memory technology, compact disk (CD)-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 712 includes computer storage media in the form of volatile and/or non-volatile memory. Memory 712 may be removable, non-removable, or a combination thereof. Exemplary memory includes solid-state memory, hard drives, optical-disc drives, etc. Computing device 700 includes one or more processors 714 that comprise processing circuitry and that read data from various entities such as bus 710, memory 712, and/or I/O components 720. Processors 714 may include one or more central processing units (CPUs) 726 and/or one or more graphics processing units (GPUs) 728. In some embodiments, one or more functions of the SeGW 120 and/or adaptive internal tunnel address arbitrator 126 described herein may include software code executed on CPUs 726 and/or GPUs 728. One or more presentation components 716 present data indications to a person or other device. Exemplary one or more presentation components 716 include a display device, speaker, printing component, vibrating component, etc. I/O ports 718 allow computing device 700 to be logically coupled to other devices including I/O components 720, some of which may be built into computing device 700. Illustrative I/O components 720 include a microphone, joystick, game pad, satellite dish, scanner, printer, wireless device, etc. In some embodiments, the I/O components 720 may include a network interface card (NIC) for coupling to a network, such as is described herein.

Radio(s) 724 represents a radio that facilitates communication with a wireless telecommunications network (such as telecommunications network 500). For example, radio(s) 724 may be used to establish communications with components of a network 105, operator core network 150, and/or core network edge 511. Illustrative wireless telecommunications technologies include code-division multiple access (CDMA), general packet radio service (GPRS), time-division multiple access (TDMA), global system for mobile communications (GSM), and the like. Radio(s) 724 may additionally or alternatively facilitate other types of wireless communications including Wi-Fi, WiMAX, LTE, and/or other voice-over-internet protocol (VoIP) communications. In some embodiments, radio(s) 724 may support multimodal connections that include a combination of 3GPP radio technologies (e.g., 4G, 5G, and/or 6G) and/or non-3GPP radio technologies. As can be appreciated, in various embodiments, radio(s) 724 can be configured to support multiple technologies, and/or multiple radios can be utilized to support multiple technologies. In some embodiments, the radio(s) 724 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

Referring to FIG. 8, a diagram is depicted generally at 800 of an exemplary cloud computing environment 810 for implementing one or more aspects of adaptive security gateway tunnel internal address arbitration, as implemented by the systems and methods described herein. Cloud computing environment 810 is but one example of a suitable cloud computing environment and is not intended to suggest any limitation as to the scope of use or functionality of the embodiments presented herein, and nor should cloud computing environment 810 be interpreted as having any dependency or requirement relating to any one or combination of components illustrated. In some embodiments, the cloud computing environment 810 is coupled to a network 800 (e.g., network 105) and/or may be executed within operator core network 150, the core network edge 511, edge server 530, or otherwise coupled to the core network edge 511 or operator core network 150.

Cloud computing environment 810 includes one or more controllers 820 comprising one or more processors and memory. The controllers 820 may comprise servers of a data center. In some embodiments, the controllers 820 are programmed to execute code to implement at least one or more aspects of an SeGW 120 and/or the adaptive internal tunnel address arbitrator 126 as described herein. For example, in one embodiment a network function for an adaptive internal tunnel address arbitrator 126 as discussed herein may be implemented as one or more virtual network functions (VNFs) 830 (which may include one or more container network functions (CNFs) running on a worker node cluster 825 established by the controllers 820.

The cluster of worker nodes 825 may include one or more orchestrated Kubernetes (K8s) pods that realize one or more containerized applications 835. In other embodiments, another orchestration system may be used. For example, the worker nodes 825 may use lightweight Kubernetes (K3s) pods, Docker Swarm instances, and/or other orchestration tools. In some embodiments, one or more elements of the environment 100 may be implemented by, or coupled to, the controllers 820 of the cloud computing environment 810 by network 105, operator core network 150, and/or core network edge 511. In some embodiments, one or more elements of a static inner IP address pool 122 and/or dynamic inner IP address pool 124 may be implemented at least in part using one or more data store persistent volumes 840 in the cloud computing environment 810.

In various alternative embodiments, system and/or device elements, method steps, or example implementations described throughout this disclosure (such as the UE, network nodes, servers, access networks, core network edge, operator core network, network functions, validation frameworks, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize the elements and/or processes, said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High-Speed Integrated Circuit (VHSIC) Hardware description language (VHDL).

As used herein, the terms “network function,” “framework,” “processor,” “controller,” “unit,” “model,” “server,” “node,” and “module” are used to describe computer processing components (e.g., processing circuitry) and/or one or more computer-executable services being executed on one or more computer processing components. In the context of this disclosure, such terms used in this manner would be understood by one skilled in the art to refer to specific network elements and are not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system comprising:
one or more processors; and
one or more computer-readable media storing computer-usable instructions that, when executed by the one or more processors, cause the one or more processors to:
obtain, at a security gateway, a connection request from a network node to initiate a connection between the network node and an operator core network of a telecommunication system, wherein the connection request includes an indication of a static inner tunnel address;
determine an availability of the static inner tunnel address for allocation to the network node;
when the static inner tunnel address is available for allocation to the network node, instantiate a secure encrypted tunnel connection between the security gateway and the network node and allocate an inner tunnel network address comprising the static inner tunnel address to the network node for communications with the operator core network through the secure encrypted tunnel; and
when the static inner tunnel address is not available for allocation to the network node, instantiate the secure encrypted tunnel connection between the security gateway and the network node and allocate the inner tunnel network address comprising a dynamic inner tunnel address to the network node for communications with the operator core network through the secure encrypted tunnel connection.

2. The system of claim 1, wherein the one or more processors are further to communicate user plane data between the network node and a user plane function of the operator core network based at least on the inner tunnel network address.

3. The system of claim 1, wherein the network node comprises at least one of: a small cell base station, a customer premises equipment gateway, or a cellular base station router.

4. The system of claim 1, wherein the network node is coupled to the security gateway through one or more of: the Internet, a backhaul internet protocol (IP), or a proprietary backhaul network.

5. The system of claim 1, wherein the security gateway is implemented on an edge server of the operator core network.

6. The system of claim 1, wherein the secure encrypted tunnel connection comprises an IPSec tunnel.

7. The system of claim 1, wherein the connection request comprises an Internet Key Exchange (IKE) request message comprising a traffic selector initiator (TSi) data field comprising the indication of the static inner tunnel address; and
wherein the security gateway determines the availability of the static inner tunnel address for allocation to the network node based on correlating the static inner tunnel address with a static address pool.

8. The system of claim 7, wherein when the static inner tunnel address is determined to be unavailable for allocation to the network node, the security gateway allocates the dynamic inner tunnel address from a dynamic address pool.

9. The system of claim 1, wherein when the static inner tunnel address is not available for allocation to the network node, the one or more processors are further to:
communicate the dynamic inner tunnel address to the network node based on a connection response message comprising a traffic selector initiator data field and a payload configuration data field indicating the dynamic inner tunnel address.

10. The system of claim 1, the security gateway further to instantiate the secure encrypted tunnel connection in response to an authentication of the network node with the security gateway.

11. A telecommunications network, the network comprising:
an operator core network; and
a security gateway coupled to the operator core network, wherein the security gateway comprises an adaptive internal network address arbitrator, wherein the adaptive internal network address arbitrator executes operations to:
receive a connection request from a network node coupled to the security gateway through a backhaul network, the connection request comprising a request to initiate a connection between the network node and the operator core network using a static inner tunnel address;
determine an availability of the static inner tunnel address for allocation to the network node based at least on a static address pool;
when the static inner tunnel address is available for allocation to the network node, instantiate a secure encrypted tunnel connection between the security gateway and the network node via the backhaul network and allocate an inner tunnel network address comprising the static inner tunnel address to the network node; and
when the static inner tunnel address is not available for allocation to the network node, instantiate the secure encrypted tunnel connection between the security gateway and the network node and allocate the inner tunnel network address comprising a dynamic inner tunnel address to the network node.

12. The network of claim 11, the security gateway further to instantiate the secure encrypted tunnel connection in response to a successful authentication of the network node with the security gateway.

13. The network of claim 11, wherein the security gateway is implemented on an edge server of the operator core network.

14. The network of claim 11, wherein the connection request comprises an IKE or IPSec request message comprising a traffic selector initiator (TSi) data field comprising an indication of the static inner tunnel address; and
wherein the security gateway determines the availability of the static inner tunnel address for allocation to the network node based on correlating the static inner tunnel address with the static address pool.

15. The network of claim 14, wherein when the static inner tunnel address is determined to be unavailable for allocation to the network node, the security gateway allocates the dynamic inner tunnel address from a dynamic address pool.

16. The network of claim 11, wherein when the static inner tunnel address is not available for allocation to the network node, the security gateway further executes operations to:
communicate the dynamic inner tunnel address to the network node based on a connection response message comprising a traffic selector initiator (TSi) data field and a payload configuration data field indicating the dynamic inner tunnel address.

17. A method comprising:
obtaining, at a security gateway, a connection request from a network node to initiate a connection between the network node and an operator core network of a telecommunication system, wherein the connection request includes an indication of a static inner tunnel address;
determining an availability of the static inner tunnel address for allocation to the network node based at least on correlating the static inner tunnel address with a static address pool;
instantiating a secure encrypted tunnel connection between the security gateway and the network node;
allocating an inner tunnel network address comprising the static inner tunnel address to the network node for communications with the operator core network through the secure encrypted tunnel when the static inner tunnel address is determined as being available for allocation to the network node; and
allocating the inner tunnel network address comprising a dynamic inner tunnel address to the network node for communications with the operator core network through the secure encrypted tunnel connection, when the static inner tunnel address is not available for allocation to the network node.

18. The method of claim 17, wherein the connection request comprises an IKE or IPSec request message comprising a traffic selector initiator (TSi) data field comprising the indication of the static inner tunnel address; and
wherein the security gateway determines the availability of the static inner tunnel address for allocation to the network node based on correlating the static inner tunnel address with the static address pool.

19. The method of claim 18, wherein when the static inner tunnel address is determined to be unavailable for allocation to the network node, the security gateway allocates the dynamic inner tunnel address from a dynamic address pool.

20. The method of claim 17, the method further comprising:
communicating the dynamic inner tunnel address to the network node based on a connection response message comprising a traffic selector initiator (TSi) data field and a payload configuration data field indicating the dynamic inner tunnel address, when the static inner tunnel address is not available for allocation to the network node.
